(19) United States
(12) Patent Application Publication
(10) Pub. No.: US 2008/0215240 A1
(43) Pub. Date: Sep. 4, 2008

(54) Integrating User Interfaces

(76) Inventors: Damian Howard, Winchester, MA (US); Melina Apostolopoulos, Arlington, MA (US); Joseph M. Geiger, Clinton, MA (US); Douglas C. Moore, North Grafton, MA (US)

Correspondence Address: FISH & RICHARDSON PC, P.O. BOX 1022, MINNEAPOLIS, MN, 55440-1022, US

(21) Appl. No.: 11/935,374

(22) Filed: Nov. 5, 2007

Related U.S. Application Data
(63) Continuation-in-part of application No. 11/750,822, filed on May 18, 2007.
Application No. 11/750,822 is a continuation-in-part of application No. 11/612,003, filed on Dec. 18, 2006.

(51) Int. Cl. G01C 21/00; G06F 3/00; G06F 3/048; B60Q 1/00; H04N 7/18; G08B 21/00; G10L 11/00; G01S 5/00

(52) U.S. Cl. 701/213; 715/762; 715/763; 715/771; 704/275; 340/436; 340/686.6; 348/148; 348/E05.024; 704/E15.001

(57) ABSTRACT

Generating a user interface includes integrating elements of a first graphical user interface into a second graphical user interface to produce a combined graphical user interface, where the first graphical user interface is for a portable navigation system and the second graphical user interface is for a vehicle media device, and controlling the vehicle media device and the portable navigation system through the combined graphical user interface.

### CROSS-REFERENCE TO RELATED APPLICATIONS

This patent application is a continuation-in-part application of U.S. patent application Ser. No. 11/750,822 (filed May 18, 2007 and titled Integrating Navigation Systems), which is a continuation-in-part application of U.S. patent application Ser. No. 11/612,003 (filed Dec. 18, 2006 and titled Integrating Navigation Systems). This application hereby claims priority to U.S. patent applications Ser. Nos. 11/750,822 and 11/612,003. U.S. patent applications Ser. Nos. 11/612,003 and 11/750,822 are hereby incorporated by reference into this patent application as if set forth herein in full.

### TECHNICAL FIELD

This patent application relates to integrating graphical user interfaces.

### BACKGROUND

In-vehicle entertainment systems and portable navigation systems sometimes include graphical displays, touch-screens, physical user-interface controls, and interactive or one-way voice interfaces. They may also be equipped with telecommunication interfaces including terrestrial or satellite radio, Bluetooth®, WiFi®, or WiMax®, GPS, and cellular voice and data technologies. Entertainment systems integrated into vehicles may have access to vehicle data, including speed and acceleration, navigation, and collision event data. Navigation systems may include databases of maps and travel information and software for computing driving directions. Navigation systems and entertainment systems may be integrated or may be separate components.

### SUMMARY

In general, this patent application describes a method that comprises integrating elements of a first graphical user interface into a second graphical user interface to produce a combined graphical user interface. The first graphical user interface is for a portable navigation system and the second graphical user interface is for a vehicle media device. The method further comprises controlling the vehicle media device and the portable navigation system through the combined graphical user interface. The method may also include one or more of the following features, either alone or in combination.

The method may include displaying the combined graphical user interface on the vehicle media device. The first graphical user interface may comprise at least one icon and the method may comprise incorporating the at least one icon into the combined graphical user interface. The first graphical user interface may comprise at least one function and the method may comprise incorporating the at least one function into the combined graphical user interface. The combined user interface may provide access to both the vehicle media device and the portable navigation system. The combined graphical user interface may incorporate navigation data and/or vehicle information that are transmitted from the portable navigation system. The combined graphical user interface may comprise display characteristics associated with the vehicle media device.

The combined graphical user interface may be displayed on the portable navigation system. The combined graphical user interface may be displayed on the vehicle media device using pre-stored bitmap data residing on the vehicle media device. The combined graphical user interface may be displayed on the vehicle media device using bitmap data transmitted from the portable navigation system.

This patent application also described a method that comprises mapping first control features of a portable navigation system to second control features of a vehicle media device, and using the second control features to control a graphical user interface that is displayed on the vehicle media device. The graphical user interface comprises first user interface elements of the portable navigation system and second user interface elements of the vehicle media device. The first control features may comprise elements of a human-machine interface for the portable navigation system and the second control features may comprise elements of a human-machine interface for the vehicle media device. The method may also include one or more of the following features, either alone or in combination.

At least one of the second control features may comprise a soft button on the graphical user interface. At least one of the second control features may comprise a concentric knob, which includes an outer knob and an inner knob. The outer knob and the inner knob are for controlling different functions via the graphical user interface.

The second control feature may comprise displaying a route view, a map view, or a driving view. Data for those views may be received at the vehicle media device from the portable navigation system.

This patent application also describes a vehicle media device that comprises a display device to display a graphical user interface, a storage device to store instructions that are executable, and a processor to execute the instructions to integrate elements of a first graphical user interface into a second graphical user interface to produce a first combined graphical user interface. The first graphical user interface is for a first portable navigation system and the second graphical user interface is for the vehicle media device. The instructions are executable to control the first portable navigation system and the vehicle media device through the first combined graphical user interface. The vehicle media device may also include one or more of the following features, either alone or in combination.

The first combined graphical user interface may be displayed on the vehicle media device. The first graphical user interface may comprise at least one icon and the processor may execute instructions to incorporate the at least one icon into the first combined graphical user interface. The processor may execute instructions to map first control features of the first portable navigation system into second control features of the vehicle media device.

The vehicle media device may be capable of integrating elements of a third graphical user interface into the second graphical user interface to form a second combined graphical user interface. The third graphical user interface may be for a second portable navigation system. The vehicle media device may be capable of controlling the second portable navigation system and the vehicle media device through the second combined graphical user interface.

This patent application also describes an integrated system comprised of a portable navigation system and a vehicle media device. The integrated system may include an integrated user interface that controls both the portable navigation system and the vehicle media device. In the integrated system, the vehicle media device may comprise a microphone, the portable navigation system may comprise voice recognition software, and the integrated system may be capable of transmitting voice data from the microphone to the voice recognition software. The integrated system may also include one or more of the following features, either alone or in combination.

The portable navigation system may be capable of interpreting the voice data as commands and sending the commands to the vehicle media device. The portable navigation system may be capable of interpreting the voice data as commands and processing the commands on the navigation device.

The portable navigation system may comprise a microphone and the vehicle media device may comprise voice recognition software. The integrated system may be capable of transmitting voice data from the microphone to the voice recognition software. The vehicle media device may be capable of interpreting the voice data as commands and sending the commands to the portable navigation system. The vehicle media device may be capable of interpreting the voice data as commands and processing the commands on the vehicle media device.

The vehicle media device may be capable of receiving traffic data from a broadcasted signal. The integrated system may be capable of transferring the traffic data to the portable navigation system for use in automatic route calculation.

The vehicle media device may be capable of notifying the navigation system that a collision has occurred. The portable navigation system may be capable of sending an emergency number and a verbal notification to the vehicle media device for making an emergency call. The emergency call may be made hands-free.

The vehicle media device may be configured with a backup camera. The integrated system may be capable of transmitting a backup camera signal to the portable navigation system for display.

The vehicle media device may be configured to receive Global Positioning System (GPS) signals. The vehicle media device may be configured to use the GPS signals to calculate latitude or longitude data. The integrated system may be capable of passing the latitude or longitude data to the portable navigation system.

The vehicle media device may comprise a proximity sensor, which is capable of detecting the proximity of a user's hand to a predetermined location, and of generating an input to the vehicle media device. The integrated system may cause the portable navigation system to generate a response based on the input from the proximity sensor. The response generated by the portable navigation system may be presented on the integrated user interface as a “zooming” icon.

The integrated system may identify the type of the portable navigation system when the portable navigation system is connected to the vehicle media device and use stored icons associated with the type of the portable navigation system.

Any of the foregoing methods may be implemented as a computer program product comprised of instructions that are stored on one or more machine-readable media, and that are executable on one or more processing devices. The method(s) may be implemented as an apparatus or system that includes one or more processing devices and memory to store executable instructions to implement the method(s).

The details of one or more examples are set forth in the accompanying drawings and the description below. Further features, aspects, and advantages will become apparent from the description, the drawings, and the claims.

### DESCRIPTION OF THE DRAWINGS

FIG. 1A is a block diagram of a vehicle information system.

FIG. 1B is a block diagram of a media head unit.

FIG. 1C is a block diagram of a portable navigation system.

FIG. 2 is a block diagram showing communication between a vehicle entertainment system and a portable navigation system.

FIGS. 3A to 3E are examples of user interfaces.

FIG. 4A is a user interface flow chart.

FIGS. 4B to 4C are examples of integrated menus on a vehicle entertainment system.

FIG. 5 is a menu on a portable navigation system.

FIGS. 6A to 6F are schematic diagrams of processes to update a user interface.

FIG. 7 is a block diagram of portions of software for communication between a vehicle entertainment system and a portable navigation system.

### DETAILED DESCRIPTION

In-vehicle entertainment systems and portable navigation systems each have unique features that the other generally lacks. One or the other or both can be improved by using capabilities provided by the other. For example, a portable navigation system may have an integrated antenna, which may provide a weaker signal than an external antenna mounted on a roof of a vehicle to be used by the vehicle's entertainment system. In-vehicle entertainment systems typically lack navigation capabilities or have only limited capabilities. When we refer to a navigation system in this disclosure, we are referring to a portable navigation system (PND), which is separate from any vehicle navigation system that may be built-in to a vehicle. An entertainment system refers to an in-vehicle entertainment system. An entertainment system may provide access to, or control of, other vehicle systems, such as a heating-ventilation-air conditioning (HVAC) system, a telephone, or numerous other vehicle subsystems. Generally speaking, the entertainment system may control, or provide an interface to, systems that are entertainment and/or non-entertainment related. A communications system that can link a portable navigation system with an entertainment system can allow either system to provide services to, or receive services from, the other device.

To this end, described herein is a system that integrates elements of an entertainment system and a navigation system. Such a system has advantages. For example, it allows information to be transmitted between the entertainment system and the navigation system, e.g., when one system has information that the other system lacks. In one example, a navigation system may store its last location when the navigation system is turned-off. However, the information about the navigation system's last location may not be reliable because the navigation system may be moved while it is off. Thereafter, when the navigation system is first turned-on, it has to rely on satellite signals to determine its current location. The process of acquiring satellite signals to obtain accurate current location information often takes five minutes or more. On the other hand, a vehicle entertainment system may have accurate current location information readily available, because a vehicle generally does not move when it is not operational. The entertainment system may provide the navigation system with this information when the navigation system is first turned-on, thereby enabling the navigation system to function without waiting for its satellite signals. The vehicle entertainment system may store its last location before the vehicle is turned off. When the vehicle is later started, it can provide this information immediately to the navigation system. A vehicle entertainment system may be equipped with global positioning system capability for tracking its current position. At any time when a portable navigation device is connected to the vehicle, the vehicle entertainment system may provide its current location information to the navigation system. The navigation system can use this information until it acquires satellite signals on its own, or it could rely solely on the location information provided from the vehicle.

An integrated entertainment and navigation system, such as those described herein, also can provide “dead reckoning” when the navigation system loses satellite signals, e.g., when the navigation system is in a tunnel or is surrounded by tall buildings. Dead reckoning is a process of computing a current location based on vehicle data, such as speed, longitude, and latitude. When the navigation system loses communication with a satellite, an integrated system can obtain the vehicle data from the vehicle via the entertainment system interface, compute the current location of the vehicle, and supply that information to the navigation system. Alternatively, if the navigation system has the capability, the vehicle can provide data from the vehicle sensors to the navigation system, and the navigation system can use this data to perform dead reckoning until satellite signals are re-acquired. The vehicle sensor data can be continuously provided to the navigation system, so that the navigation system can use satellite signals and vehicle data in combination to improve its ability to track the vehicle current location.

An integrated system also allows a driver to focus on only one screen, instead of dividing attention between two (or more) screens. For example, an integrated system may display navigation information (maps, routes, etc.) on the screen of the entertainment system. An integrated system may also overlay the display of information about an audio source over a view of a map, thereby providing a combined display of information from two separate systems, one of which is not permanently integrated into the vehicle.

Navigation and entertainment systems can include both graphical user interfaces and human-machine user interfaces.

In general, a graphical user interface (GUI) is an interface that is often displayed on a screen and that contains elements, such as menus and icons. A menu may include a list of items that a user can browse through in order to select a particular item. A menu item can be, e.g., an icon or a string of characters, or both. Generally speaking, an icon is a graphic symbol associated with a menu item or a functionality.

A human-machine user interface refers to the physical aspect of a system's user interface. A human-machine user interface can contain elements such as switches, knobs, buttons, and the like. For example, an on/off switch is an element of the human-machine user interfaces of most systems. In an entertainment system, a human-machine user interface may include elements such as a volume control knob, which a user can turn to adjust the volume of the entertainment system, and a channel seeking button, which a user can press to seek the next radio station that is within range. One or more of knobs may be a concentric knob. A concentric knob is an inner knob nested inside an outer knob, with the inner knob and the outer knob controlling different functions.

A navigation system is often controlled via a touch-screen graphical user interface with touch-sensitive menus. An entertainment system is often controlled via physical buttons and knobs. For example, a user may press a button to select a pre-stored radio station. A user may turn a knob to increase or decrease the volume of a sound system. An integrated system, such as those described herein, could be less user-friendly if the controls for its two systems were to remain separate. For example, an entertainment system and a navigation system may be located far from each other. A driver may have to stretch out to reach the control of one system or the other.

Thus, the integrated system described herein also integrates elements of the graphical and human-machine interfaces of its two systems, namely the entertainment and navigation system. Accordingly, the user interface of an integrated system may be a combination of portions of the graphical user interface and/or human-machine user interface elements from both the entertainment system and the navigation system.

Elements contained in a user interface of a system that are used to control that system are referred to herein as control features. To integrate user interfaces of a navigation system and entertainment system, some functions on the navigation system that are activated using the control features of the navigation system will be chosen and activated using control features of the entertainment system. This is referred to as “mapping” in this application. During a mapping process, elements of the user interface of the navigation system may be mapped to the elements of the user interface of the entertainment of the same modality or different modalities. For example, a button press on the navigation system may be translated to a button press on the entertainment system, or it could be translated to a knob rotation. If both the navigation system and the entertainment system have a touch screen interface, then the mapping may be similar for most elements (touch screen to touch screen). But, there may still be some differences. For example, the touch screen in the entertainment system may be larger than the touch screen of the navigation system, and it may accommodate more icons on the display. Also, some touch functions on the navigation system may still be mapped to some other modality on the entertainment system human-machine user interface, such as a button press on the entertainment system.

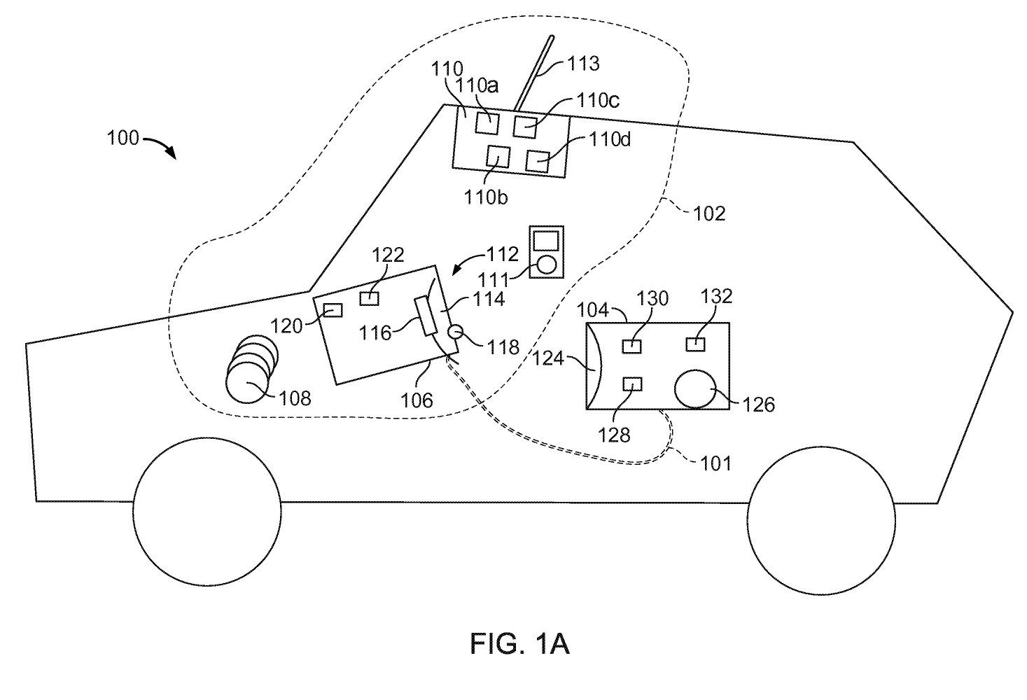

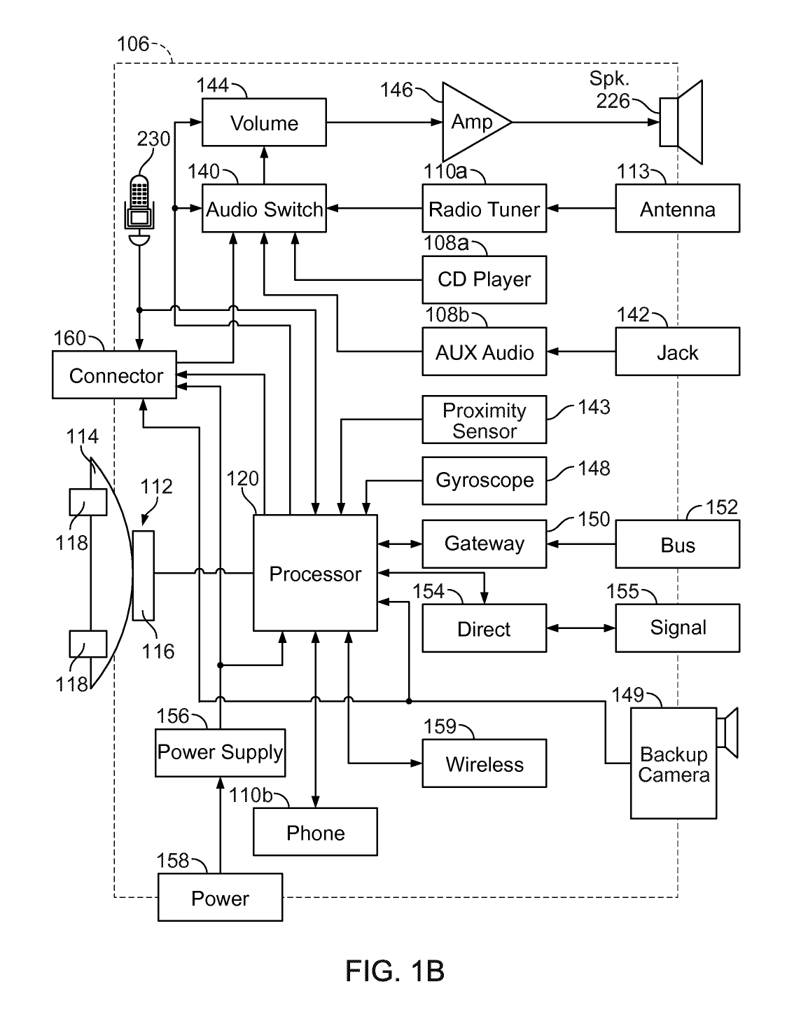

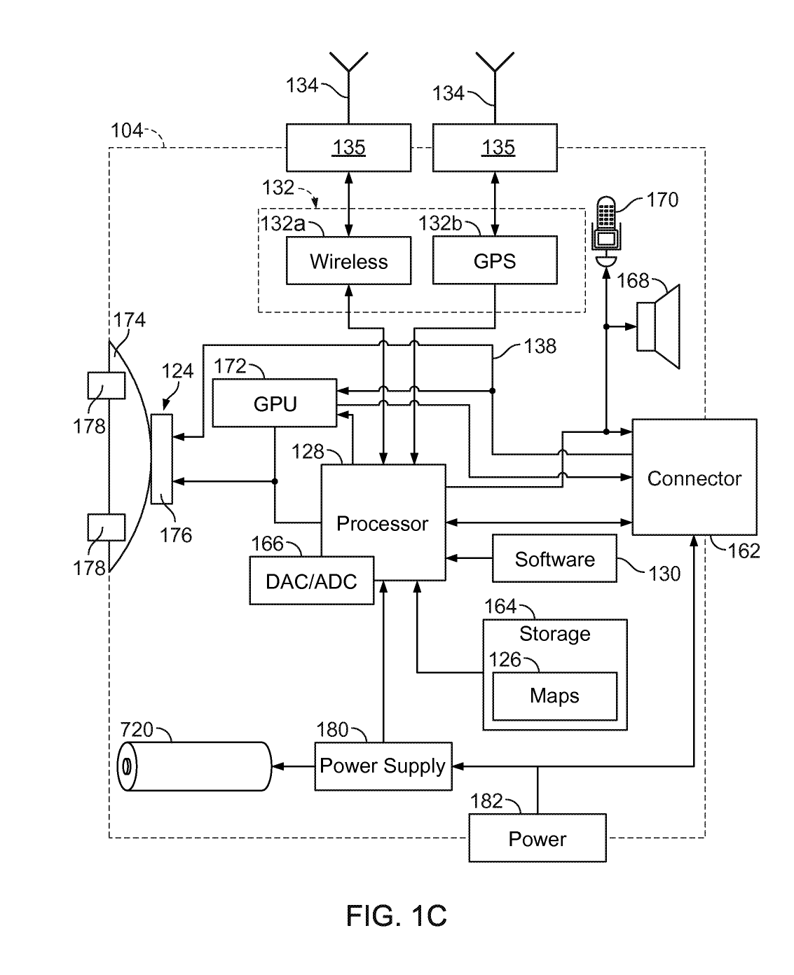

Referring to FIG. 1A, that figure illustrates an integrated system of an entertainment system and a navigation system. An entertainment system 102 and a navigation system 104 may be linked within a vehicle 100 as shown in FIG. 1A. In some examples, the entertainment system 102 includes a head unit 106, media sources 108, and communications interfaces 110. The navigation system 104 is connected to one or more components of the entertainment system 102 through a wired or wireless connection 101. The media sources 108 and communications interfaces 110 may be integrated into the head unit 106 or may be implemented separately. The communications interfaces may include radio receivers 110a for FM, AM, or satellite radio signals, a cellular interface 110b for two-way communication of voice or data signals, a wireless interface 110c for communicating with other electronic devices such as wireless phones or media players 111, and a vehicle communications interface 110d for receiving data from within the vehicle 100. The interface 110c may use, for example, Bluetooth®, WiFi®, WiMax® or any other wireless technology. References to Bluetooth® in the remainder of this description should be taken to refer to Bluetooth® or to any other wireless technology or combination of technologies for communication between devices.

The communications interfaces 110 may be connected to at least one antenna 113, which may be a multifunctional antenna capable of receiving AM, FM, satellite radio, GPS, Bluetooth, etc., transmissions. The head unit 106 also has a user interface 112, which may be a combination of a graphics display screen 114, a touch screen sensor 116, and physical knobs and switches 118, and may include a processor 120 and software 122. Proximity sensor 143 (shown in FIG. 1B) may be used to detect when a user's hand is approaching one or more controls, such as those described above. The proximity sensor 143 may be used to change information on graphics display screen 114 in conjunction with one or more of the controls.

In some examples, the navigation system 104 includes a user interface 124, navigation data 126, a processor 128, navigation software 130, and communications interfaces 132. The communications interface may include GPS, for finding the system's location based on GPS signals from satellites or terrestrial beacons, a cellular interface for transmitting voice or data signals, and a Bluetooth®, WiFi®, or WiMax® interface for communicating with other electronic devices, such as wireless phones.

In some examples, the various components of the head unit 106 are connected as shown in FIG. 1B. An audio switch 140 receives audio inputs from various sources, including the radio tuner 110a that is connected to antenna 113, media sources such as a CD player 108a and an auxiliary input 108b, which may have a jack 142 for receiving input from an external source. The audio switch 140 also receives audio input from the navigation system 104 (not shown) through a connector 160. The audio switch sends a selected audio source to a volume controller 144, which in turn sends the audio to a power amplifier 146 and a loudspeaker 226. Although only one loudspeaker 226 is shown, the vehicle 100 typically has several. In some examples, audio from different sources may be directed to different loudspeakers, e.g., audible navigation prompts may be sent only to the loudspeaker nearest the driver while an entertainment program continues playing on other loudspeakers. In some examples, an audio switch may also mix signals by adjusting the volumes of different signals. For example, when the entertainment system is outputting an audible navigation prompt, a contemporaneous music signal may be reduced in volume so that the navigation prompt is audible over the music. The audio switch 140 and the volume controller 144 are both controlled by the processor 120. The processor may receive inputs from the touch screen 116, buttons 118, and proximity sensor 143, and outputs information to the display screen 114. The proximity sensor 143 can detect the proximity of a user's hand or head. The input from the proximity sensor can be used by the processor 120 to decide where output information should be displayed or to which speaker audio output should be routed. In some examples, inputs from proximity sensor 143 can be used to control the portable navigation system 104. As an illustration, when the proximity sensor 143 detects that a user's hand is close to the touch screen of the vehicle, a command is issued to the portable navigation device in response to the detection. The type of command that is issued depends, e.g., on the content of the touch screen at the time of detection. For example, if the touch screen relates to navigation, and has a touch-based control therefor, an appropriate navigation command may be issued via the proximity sensor. Thus, the system described herein detects proximity to the human-machine interface of the vehicle, and a command is issued to the navigation device to cause it to respond in some manner to the sensed proximity to the vehicle controls. In another example, if the entertainment system is set up to control the navigation system, and the system currently is in map view, when the users hand is sensed near the vehicle human-machine interface, icons for zooming the map may show up on screen. The system sends a command to the navigation system to provide these icons, if the system does not already have them.

In some examples, some parts of the interface 112 may be physically separate from the components of the head unit 106.

The processor may receive inputs from individual devices, such as a gyroscope 148 and backup camera 149. The processor may exchange information via a gateway 150 with an information bus 152, and process signal inputs from a variety of sources 155, such as vehicle speed sensors or the ignition switch. Whether particular inputs are direct signals or are communicated over the bus 152 will depend on the architecture of the vehicle 100. The vehicle may be equipped with at least one bus for communicating vehicle operating data between various modules. There may be an additional bus for entertainment system data. The head unit 106 may have access to one or more of these busses. A gateway module in the vehicle (not shown) may convert data from a bus that is not available to the head unit 106 to a bus that is available to the head unit 106. The head unit 106 may be connected to more than one bus and may perform the conversion function for other modules in the vehicle. The processor may also exchange data with a wireless interface 159. This can provide connections to media players or wireless telephones, for example, which may be inside of, or external to, the vehicle. The head unit 106 may also have a wireless telephone interface 110b built-in. Any of the components shown as part of the head unit 106 in FIG. 1B may be integrated into a single unit or may be distributed in one or more separate units. The head unit 106 may use a gyroscope 148, or other vehicle sensors, such as a speedometer, steering angle sensor, accelerometer (not shown), to sense speed, acceleration and rotation (e.g., turning). Any of the inputs shown connected to the processor may also be passed on directly to the connector 160, as shown for the backup camera 149. Power for the entertainment system may be provided through the power supply 156 by power 158, a power source.

As noted above, the connection from the entertainment system 102 to the navigation system 104 may be wireless. As such, the arrows between various parts of the entertainment system 102 and the connector 160 in FIG. 1B would run instead between the various parts and the wireless interface 159. In wired examples, the connector 160 may be a set of standard cable connectors, a customized connector for the navigation system 104, or a combination of connectors.

The various components of the navigation system 104 may be connected as shown in FIG. 1C. The processor 128 receives inputs from communications interfaces 132, including a wireless interface (such as a Bluetooth®, WiFi®, or WiMax® interface) 132a and a GPS interface 132b, each with its own antenna 134 or a shared common antenna. The wireless interface 132a and GPS interface 132b may include connections 135 for external antennas or the antennas 134 may be internal to the navigation system 104. The processor 128 also may also transmit and receive data through a connector 162, which mates to the connector 160 of the head unit 106 (in some examples with cables in between, as discussed below). Any of the data communicated between the navigation system 104 and the entertainment system 102 may be communicated though either the connector 162, the wireless interface 132a, or both. An internal speaker 168 and microphone 170 are connected to the processor 128. The speaker 168 may be used to output audible navigation instructions, and the microphone 170 may be used to capture a speech input and provide it to the processor 128 for voice recognition. The speaker 168 may also be used to output audio from a wireless connection to a wireless phone using wireless interface 132a or via connector 162. The microphone 170 may also be used to pass audio signals to a wireless phone using wireless interface 132a or via connector 162. Audio input and output may also be provided by the entertainment system 102 to the navigation system 104. The navigation system 104 includes a storage 164 for map data 126, which may be, for example, a hard disk, an optical disc drive or flash memory. This storage 164 may also include recorded voice data to be used in providing the audible instructions output to speaker 168. Alternatively, navigation system 104 could run a voice synthesis routine on processor 128 to create audible instructions on the fly, as they are needed. Software 130 may also be in the storage 164 or may be stored in a dedicated memory.

The connector 162 may be a set of standard cable connectors, a customized connector for the navigation system 104 or a combination of connectors.

A graphics processor (GPU) 172 may be used to generate images for display through the user interface 124 or through the entertainment system 102. Alternatively, video processing could be handled by the main processor 128, and the images may be output through the connector 162 by the processor 128. The processor 128 may also include digital/analog converters (DACs and ADCs) 166, or these functions may be performed by dedicated devices. The user interface 124 may include an LCD or other video display screen 174, a touch screen sensor 176, and controls 178. In some examples, video signals, such as from the backup camera 149, are passed directly to the display 174 via connector 162 or wireless interface 132a. A power supply 180 regulates power received from an external source 182 or from an internal battery 720. The power supply 180 may also charge the battery 720 from the external source 182. Connection to external source 182 may also be available through connector 162. Communication line 138 that connects connector 162 and user interface 124 may be used as a backup camera signal line to pass the backup camera signals to the navigation system. In this way, images of the backup camera of the entertainment system can be displayed on the navigation system's screen.

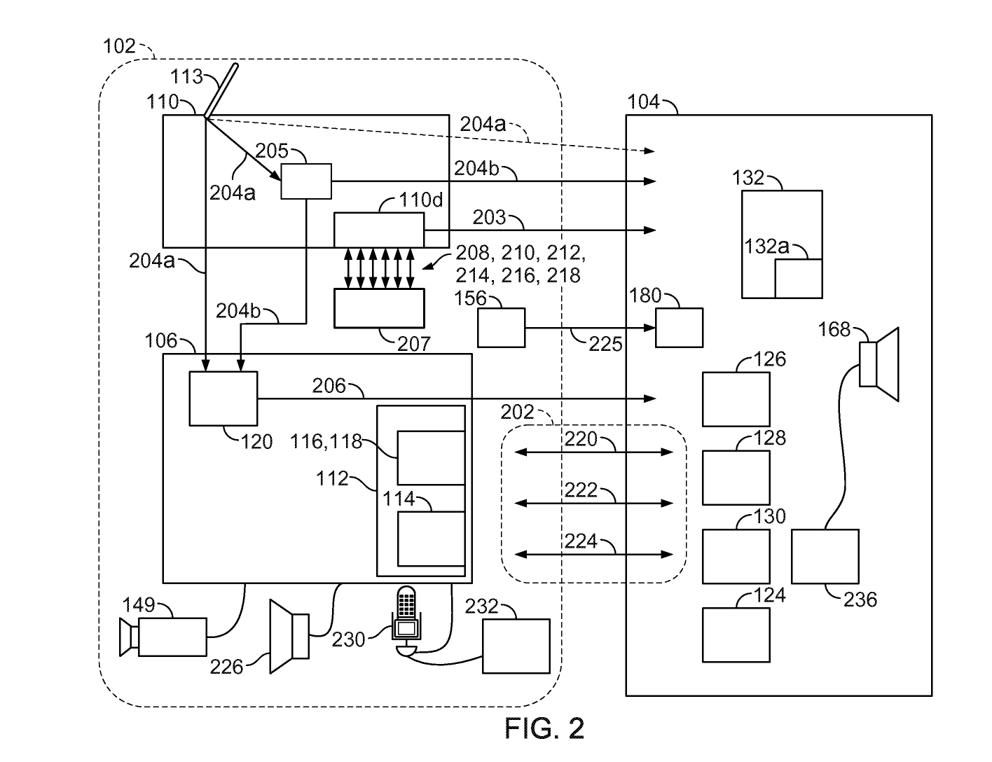

In some examples, as shown in FIG. 2, the navigation system 104 can use signals available through the entertainment system 102 to improve the operation of its navigation function. The external antenna 113 on the vehicle 100 may provide a better GPS signal 204a than one integrated into the navigation system 104. Such an antenna 113 may be connected directly to the navigation system 104, as discussed below, or the entertainment system 102 may relay the signals 204a from the antenna after tuning them itself with a tuner 205 to create a new signal 204b. In some examples, the entertainment system 102 may use its own processor 120 in the head unit 106 or elsewhere to interpret signals 204a received by the antenna 113 or signals 204b received from the tuner 205 and relay longitude and latitude data 206 to the navigation system 102. This may also be used when the navigation system 104 requires some amount of time to determine a location from GPS signals after it is activated—the entertainment system 102 may provide a current location to the navigation system 104 as soon as the navigation system 104 is turned-on or connected to the vehicle, allowing it to begin providing navigation services without waiting to determine the vehicle's location. Because it is connected to the vehicle 100 through a communications interface 110d (shown connected to a vehicle information module 207), the entertainment system 102 may also be able to provide the navigation system 104 with data 203 not otherwise available to the navigation system 104, such as vehicle speed 208, acceleration 210, steering inputs 212, and events such as braking 214, airbag deployment 216, or engagement 218 of other safety systems such as traction control, roll-over control, tire pressure monitoring.

The navigation system 104 can use the data 203 for improving its calculation of the vehicle's location, for example, by combining the vehicle's own speed readings 208 with those derived from GPS signals 204a, 204b, or 206, or the navigation system's own GPS signals 132b (shown in FIG. 1C), the navigation system 104 can make a more accurate determination of the vehicle's true speed. Signal 206 may also include gyroscope information that has been processed by processor 120 as mentioned above. If a GPS signal 204a, 204b, or 206 is not available, for example, if the vehicle 100 is surrounded by tall buildings or in a tunnel and does not have a line of sight to enough satellites, the speed 208, acceleration 210, steering 212, and other inputs 214 or 218 characterizing the vehicle's motion can be used to estimate the vehicle's course by dead reckoning. Gyroscope information that has been processed by processor 120 and is provided by 206 may also be used. In some examples, the computations of the vehicle's location based on information other than GPS signals may be performed by the processor 120 and relayed to the navigation system in the form of a longitude and latitude location. If the vehicle has its own built-in navigation system, such calculations of vehicle location may also be used by that system. In some examples, vehicle sensor information can be passed to the navigation system, and the navigation system can estimate the vehicle's position by performing dead reckoning calculations within the navigation device (e.g. processor 128 runs a software routine to calculate position using the vehicle sensor data). Other data 218 from the entertainment system of use to the navigation system may include traffic data received through the radio receiver 110a and antenna 113 or wireless phone interface, collision data, and vehicle status such as doors opening or closing, engine start, headlights or internal lights turned on, and audio volume. This can be used for such things as changing the display of the navigation system to compensate for ambient light, locking-down the user interface while driving, or calling for emergency services in the event of an accident if the navigation system has a cell phone capability and the car does not have its own wireless phone interface. For example, the navigation system may also use data 218, especially the traffic data, for automatic recalculation of a planned route to minimize travel delays or to adjust the navigation system routing algorithm. In some examples, the entertainment system may notify the navigation system that a collision has occurred, e.g., via data 218. The navigation system, after receiving the notification, may send an emergency number and/or a verbal notification that are pre-stored on the navigation system to the entertainment system. This information may be used to make a telephone call to the appropriate emergency personnel. The telephone call may be a “hands-free” call, e.g., one that is made automatically without requiring the user to physically dial the call. Such a call may be initiated via the verbal notification output by the navigation system, for example.

The navigation system 104 may exchange, with the entertainment system 102, data including video signals 220, audio signals 222, and commands or information 224, which are collectively referred to as data 202. Power for the navigation system 104, for charging or regular use, may be provided from the entertainment system's power supply 156 to the navigation system's power supply 180 through connection 225. If the navigation system's communications interfaces 132 include a wireless phone interface 132a and the entertainment system 102 does not have one, the navigation system 104 may enable the entertainment system 102 to provide hands-free calling to the driver through the vehicle's speakers 226 and a microphone 230. The microphone and speakers of the navigation system may be used to provide hands free functionality. The vehicle entertainment system speakers and microphone may be used to provide hands free functionality. Alternatively, some combination thereof may be used, such as using the vehicle speakers and the navigation system's microphone (e.g., for cases where the vehicle does not have a microphone). The audio signals 222 carry the voice data from the driver to the wireless phone interface 132a in the navigation system and carry any voice data from a call back to the entertainment system 202. The audio signals 222 can also be used to transfer audible instructions such as driving directions or voice recognition acknowledgements from the navigation system 104 to the head unit 106 for playback on the vehicle's speakers 226 instead of using a built-in speaker 168 in the navigation system 104.

The audio signals 222 may also be used to provide hands-free operation from one device to another. In one example, components of hands-free system 232 may include a pre-amplifier for a microphone, an amplifier for speakers, digital/analog converters, logic circuitry to route signals appropriately, and signal processing circuitry (for, e.g., equalization, noise reduction, echo cancellation, and the like). If the entertainment system 102 has a microphone 230 for either a hands-free system 232 or other purpose, it may receive voice inputs from microphone 230 and relay them as audio signals 222 to the navigation system 104 for interpretation by voice recognition software on the navigation system and receive audio responses 222, command data and display information 224, and updated graphics 220 back from the navigation system 104. Alternatively, the entertainment system 102 may also interpret the voice inputs itself, using its own voice recognition software which may be a part of software 122, to send control commands 224 directly to the navigation system 204. If the navigation system 104 has a microphone 170 for either a hands-free system 236 or other purposes, its voice inputs can be interpreted by voice recognition software which may be part of software 130 on the navigation system 104 and may be capable of controlling aspects of the entertainment system by sending control commands 224 directly to the entertainment system 102. In some examples, the navigation system 104 also functions as a personal media player (e.g., an MP3 player), and the audio signals 222 may carry a primary audio program to be played back through the vehicle's speakers 226. In some examples, the navigation system 104 has a microphone 170 and the entertainment system 102 includes voice recognition software. The navigation system may receive voice input from microphone 170 and replay that voice input as audio signals to the entertainment system. The voice recognition software on the entertainment system interprets the audio signals as commands. For example, the voice recognition software, may decode commands from the audio signals. The entertainment system may send the commands to the navigation system for processing or process the commands itself.

In summary, voice signals are transmitted from one device that has a microphone to a second device that has voice recognition software. The device that has the voice recognition software will interpret the voice signals as commands. The device that has the voice recognition could send command information back to the other device, or it could execute a command itself.

The general concept is that the vehicle entertainment system and the portable system can be connected by the user, and that there is voice recognition capability in one device (any device that has voice recognition will generally have a microphone built into it). Upon connecting the two devices, voice recognition capability in one device is made available to the other device. The voice recognition can be in the portable device, and it can made available to the vehicle when connected, or the voice recognition can be in the vehicle media system, and be made available to the portable device.

In some examples, the head unit 106 can receive inputs on its user interface 116 or 118 and relay these to the navigation system 104 as commands 224. In this way, the driver only needs to interact with one device, and connecting the navigation system 104 to the entertainment system 102 allows the entertainment system 102 to operate as if it included navigation features.

The navigation system 104 may be used to display images from the entertainment system 102, for example, from the backup camera 149 or in place of using the head unit's own screen 114. Such images can be passed to the navigation system 104 using the video signals 220. This has the advantage of providing a graphical display screen for a head unit 106 that may have a more-limited display 114. For example, images from the backup camera 149 may be relayed to the navigation system 104 using video signals 220 and, when the vehicle is put in to reverse, as indicated by a direct input 154 or over the vehicle bus 152 (FIG. 1B), this can be communicated to the navigation system 104 using the command and information link 224. At this point, the navigation system 104 can automatically display the backup camera's images. This can be advantageous when the navigation system 104 has a better or move-visible screen 174 than the head unit 106 has, giving the driver the best possible view.

In cases where the entertainment system 102 does include navigation features, the navigation system 104 may be able to supplement or improve on those features, for example, by providing more-detailed or more-current maps though the command and information link 224 or by offering better navigation software or a more powerful processor. In some examples, the head unit 106 may be equipped to transmit navigation service requests over the command and information link 224 and receive responses from the navigation system's processor 128. In some examples, the navigation system 104 can supply software 130 and data 126 to the head unit 106 to use with its own processor 120. In some examples, the entertainment system 102 may download additional software to the navigation system, for example, to update its ability to calculate location based on the specific information that vehicle makes available.

By providing navigation data through the entertainment system, it is possible to mount the navigation system in a location—even locations that are not that visible to the driver—and still use the navigation system. Connections (e.g., interfaces, data formats, and the like) between the navigation system and the entertainment system may be standard or proprietary. A standard connection may allow navigation systems from various manufacturers to work in a vehicle without customization. If the navigation system uses a proprietary connection, the entertainment system 102 may include software or hardware that allows it to interface with such a connection.

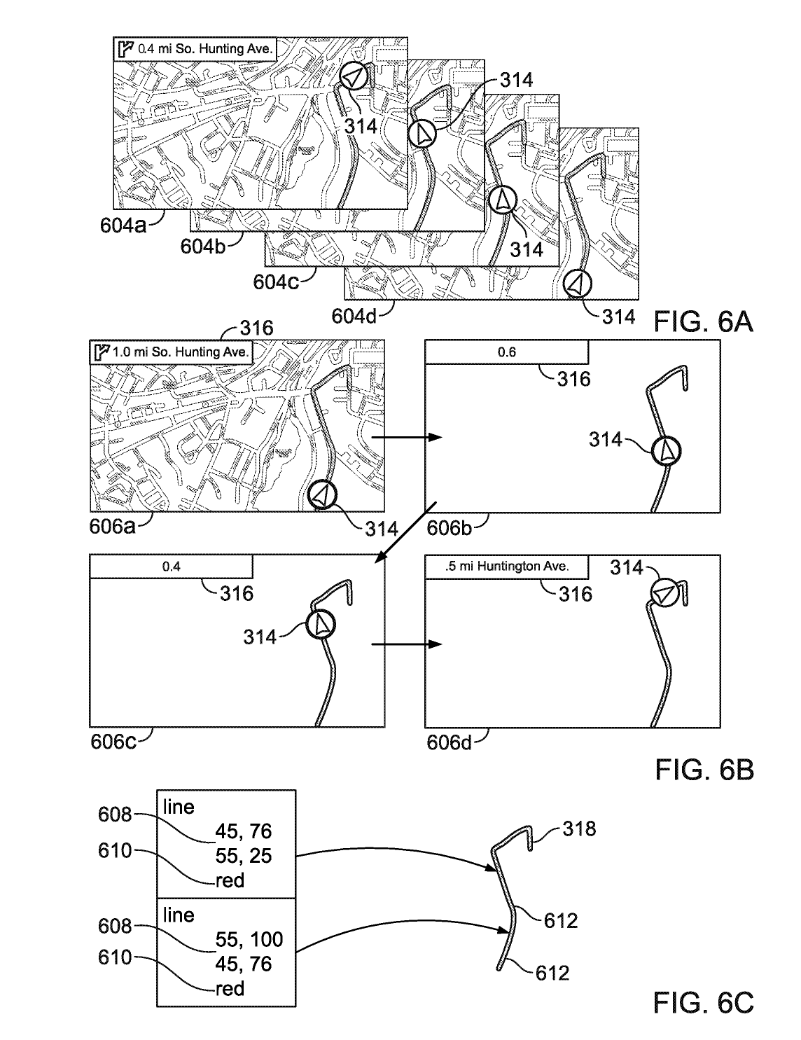

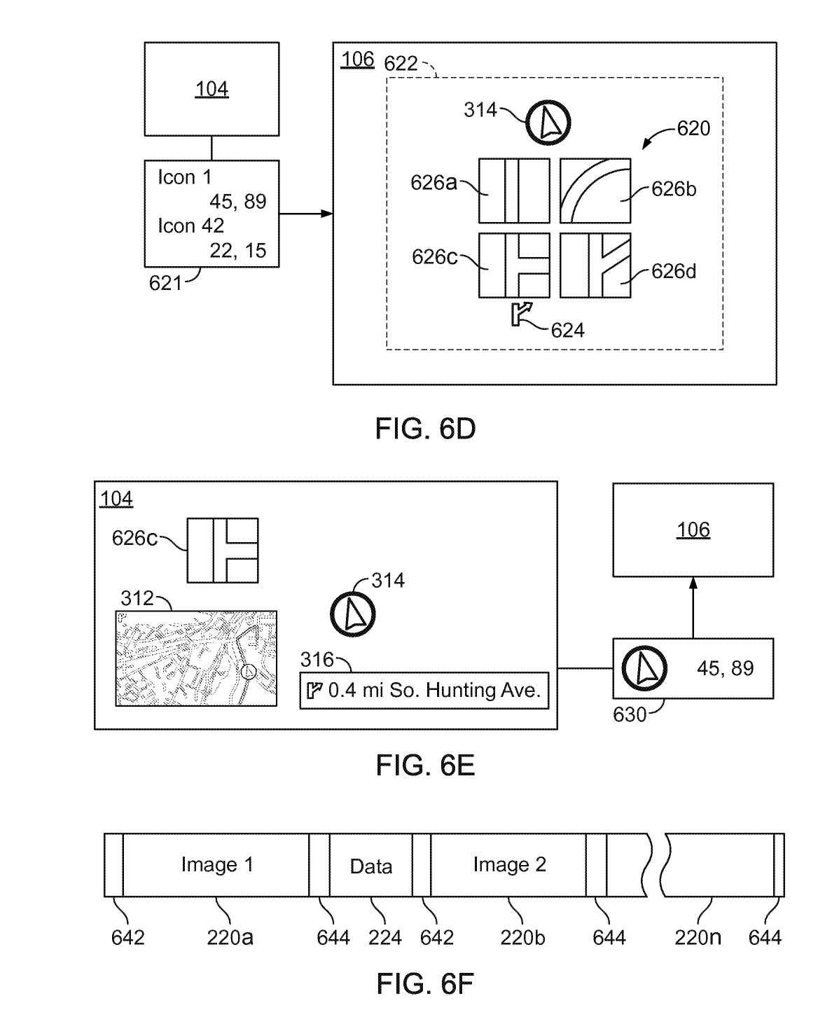

Referring now to FIGS. 6A-6C, a video image 604a may be transmitted from the navigation system 104 to the head unit 106. This image 604a could be transmitted as a data file using an image format such as BMP, JPEG or PNG or the image may be streamed as an image signal over a connection such as DVI or Firewire® or analog alternatives like RBG. The head unit 106 may decode the image signal and deliver it directly to the screen 114 or it may filter it, for example, via upscaling, downscaling, or cropping to accommodate the resolution of the screen 114. The head unit may combine part of or the complete image 604a with screen image elements generated by the head unit itself or other accessory devices to generate mixed images.

The image may be provided by the navigation system in several forms including a full image map, difference data, or vector data. For a full image map, as shown in FIG. 6A, each frame 604a-604d of image data contains a complete image. For difference data, as shown in FIG. 6B, a first frame 606a includes a complete image, and subsequent frames 606b-606d only indicate changes to the first frame 606a (note moving indicator 314 and changing directions 316). A complete frame may be sent periodically, as is done in known compression methods, such as MPEG. Vector data, as shown in FIG. 6C, provides a set of instructions that tell the processor 120 how to draw the image, e.g., instead of a set of points to draw the line 318, vector data includes an identification 608 of the end points of segments 612 of the line 318 and an instruction 610 to draw a line between them.

The image may also be transmitted as bitmap data, as shown in FIG. 6D. In this example, the head unit 106 maintains a library 622 of images 620 and the navigation system 104 provides instructions of which images to use to form the desired display image. Storing the images 620 in the head unit 106 allows the navigation system 104 to simply specify 621 which elements to display. This can allow the navigation system 104 to communicate the images it wishes the head unit 106 to display using less bandwidth than may be required for a full video image. Storing the images 620 in the head unit 106 may also allow the maker of the head unit to dictate the appearance of the display, for example, maintaining a branded look-and-feel different from that used by the navigation system 104 on its own interface 124. The pre-arranged image elements 620 may include icons like the vehicle location icon 314, driving direction symbols 624, or standard map elements 626 such as straight road segments 626a, curves 626b, and intersections 626c, 626d. Using such a library of image elements may require some coordination between the maker of the navigation system 104 and the maker of the head unit 106 in the case where the manufacturers are different, but could be standardized to allow interoperability. Such a technique may also be used with the audio navigation prompts discussed above—pre-recorded messages such as “turn left in 100 yards” may be stored in the head unit 106 and selected for playback by the navigation system 104.

In a similar fashion, as shown in FIG. 6E, the individual screen elements 620 may be transmitted from the navigation system 104 with instructions 630 on how they may be combined. In this case, the elements may include specific versions such as actual maps 312 and specific directions 316, such as street names and distance indications, that would be less likely to be stored in a standardized library 622 in the head unit 106. Either approach may simplify generating mixed-mode screen images that contain graphical elements of both the entertainment system 102 and the navigation system 104, because the head unit 106 does not have to analyze a full image 602 to determine which portion to display.

When an image is being transmitted from the navigation system 104 to the head unit 106, the amount of bandwidth required may dominate the connections between the devices. For example, if a single USB connection is used for the video signals 220, audio signals 222, and commands and information 224, a full video stream may not leave any room for control data. In some examples, as shown in FIG. 6F, this can be addressed by dividing the video signals 220 into blocks 220a, 220b, . . . 220n and interleaving blocks of commands and information 224 in between them. This can allow high priority data like control inputs to generate interrupts that assure they get through. Special headers 642 and footers 644 may be added to the video blocks 220a-220n to indicate the start or end of frames, sequences of frames, or full transmissions. Other approaches may also be used to transmit simultaneous video, audio, and data, depending on the medium used.

Entertainment system 102 may include software that can do more than relay the navigation system's interfaces through the entertainment system. The entertainment system 102 may include software that can generate an integrated user interface, through which both the navigation system and the entertainment system may be controlled. For example, the software may incorporate one or more elements from the graphical user interface of the navigation system into a “native” graphical user interface provided by the entertainment system. The result is a combined user interface that includes familiar icons and functions from the navigation system, and that are presented in a combined interface that has roughly the same look and feel as the entertainment system's interface.

The following describes integrated user interfaces generated by an entertainment system and displayed on the entertainment system. Integrated interfaces, however, may also be generated by the navigation system 104 and displayed on the navigation system. Alternatively, integrated interfaces may be generated by the navigation system and displayed on the vehicle entertainment system, or vice versa,

There are numerous types of navigation systems on the market, each offering different functionalities and different user interfaces. The differences may be in both their graphical user interfaces and human-machine user interfaces. The content of an integrated interface will depend, to a great extent, on the features available from a particular navigation system. In order to construct a combined interface, in this example, software in the vehicle entertainment system first identifies the type (e.g., brand/model) of navigation system that is connected to the entertainment system. Here, identification is performed via a “handshake” protocol, which may be implemented when the navigation systems and entertainment system are first electrically connected. In this context, an electrical connection may include a wired connection, a wireless connection, or a combination of the two. Identification may also be performed by a user, who provides the type information of the navigation system manually to the vehicle entertainment system.

During the initial handshake protocol, information about the connected navigation system is transmitted to the entertainment system. Such information may be transmitted through communication interfaces between the entertainment system and the navigation system, such as those described above. The transmitted information may include type information, which identifies the type, e.g., brand/model/etc. of the navigation system. The type information may be coded in an identifier field of a message having a predefined format. In this example, processor 120 of the entertainment system uses the obtained type information to identify the navigation system, and to generate an integrated user interface based on this identification. The processor 120 can generate graphical portions of the user interface either using pre-stored bitmap data or using data received from the navigation system, as described in more detail below.

Each type of device may have a user interface functional hierarchy. That is, each device has certain capabilities or functions. In order to access these, a user interacts with the device's human-machine interface. The designers of each navigation system have chosen a way to organize navigation system functions for presentation to, and interaction with, a user. These navigation system functions are associated with corresponding icons. The entertainment system has its own way of organizing its functions for presentation to, and interaction with, a user. The functions of the navigation system may be integrated into the entertainment system in a way that is consistent with how the entertainment system organizes its other functions, but also in a way that takes advantage of the fact that a user of the navigation system will be familiar with graphics that are typically displayed on the navigation system.

Because the human-machine interface of the entertainment system may be different from that of the navigation system, the organizational structure of navigation functions may be modified when integrated into the entertainment system. Some aspects, and not others, may be modified, depending on what is logical, and on what provides a beneficial overall experience for the user. It is possible to determine, in advance, how to change this organization, and to store that data within the entertainment system, so that when the entertainment system detects a navigation system and determines what type of system it is, the entertainment system will know how to perform the organizational mapping. This process may be automated.

By way of example, it may be determined that a high level menu, which has five icons visible on a navigation system, makes sense when integrated with the entertainment system. Software in the entertainment system may obtain those icons and display them on a menu bar so that the same five icons are visible. In some examples, the case may be that the human-machine interfaces for choosing the function associated with an icon are different (e.g., a rotary control vs. a touch screen), but the menu hierarchies for the organization of functions are the same. However, at a different place in the navigation system menu structure, it may be determined that the logical arrangement of available functions provided by the navigation system is not consistent with a logical approach of the entertainment system and, therefore, the entertainment system may organize the functions differently. For example, the entertainment system could decide that one function provided is not needed or desired, and simply not present that function. Alternatively, the entertainment system may decide that a function more logically belongs at a different point in its hierarchy, and move that function to a different point in the vehicle entertainment system user interface organization structure. The entertainment system could decide to remove whole levels of a hierarchy, and promote all of the lower level functions to a higher level. The point is, the organizational structure of the navigation system can be remapped to fit the organizational structure of the entertainment system in any manner. This is done so that, whether the user is interacting with the navigation system, phone, HVAC, audio system, or the like, the organization of functions throughout those systems is presented in as consistent a fashion as possible.

To help reduce confusion when a user switches between use of the navigation system on its own and use within the vehicle, the entertainment system uses the graphics that are associated with particular functions in the navigation system and associates them with the same functions when controlled by the entertainment system user interface.

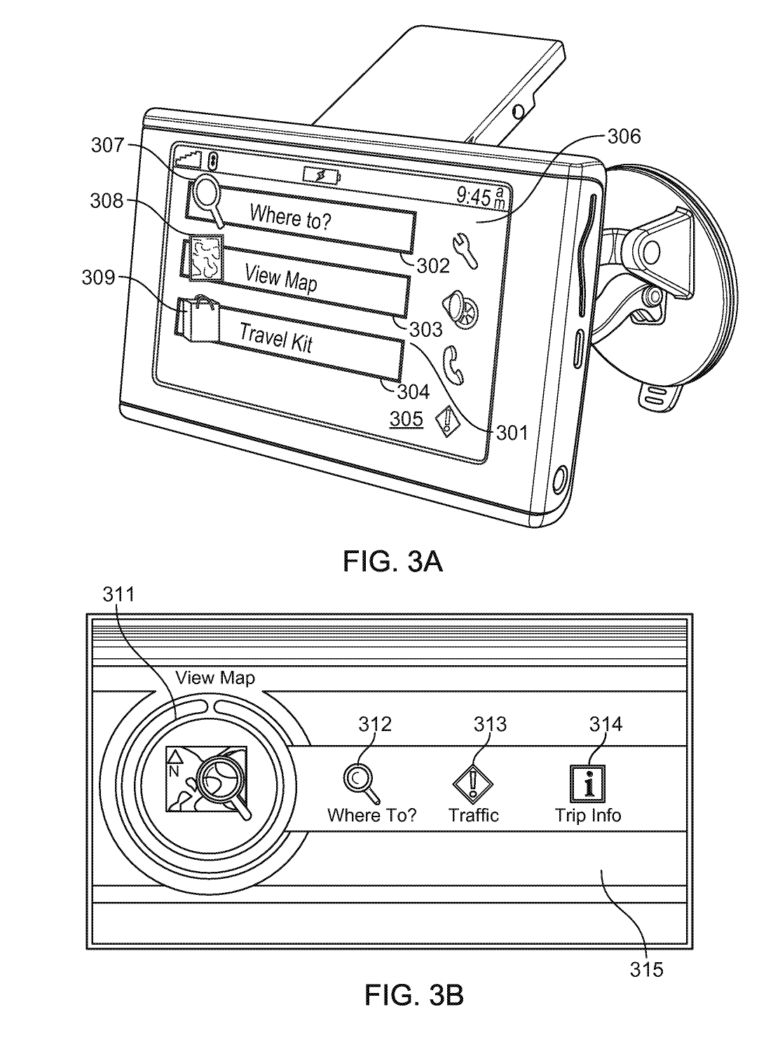

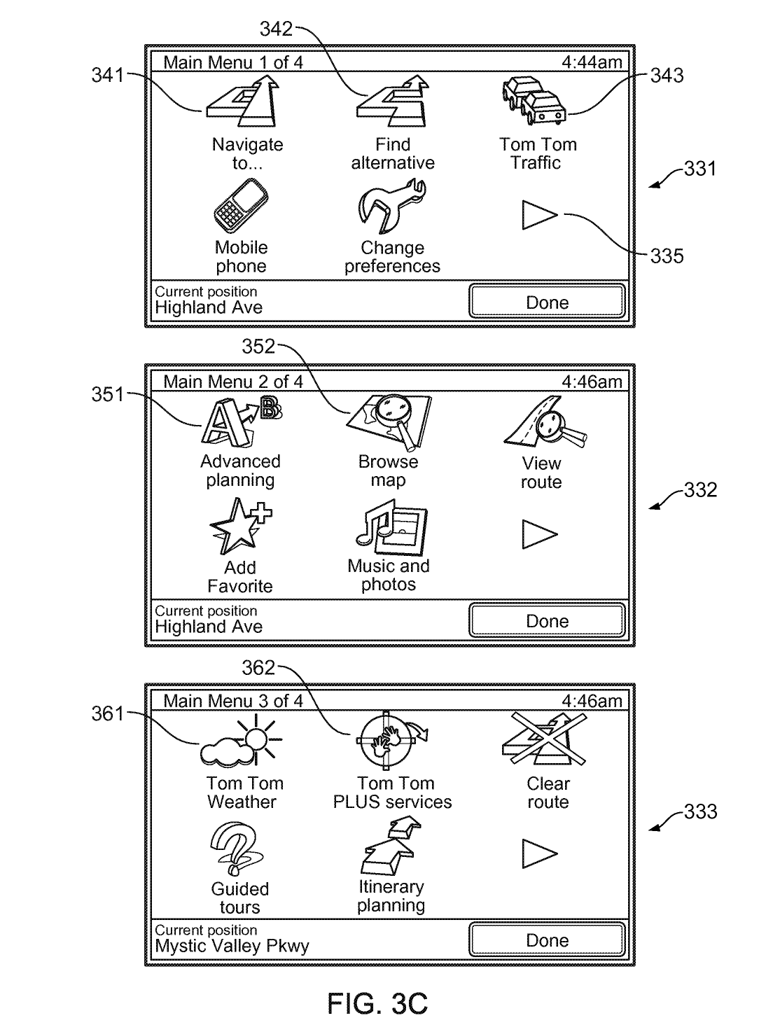

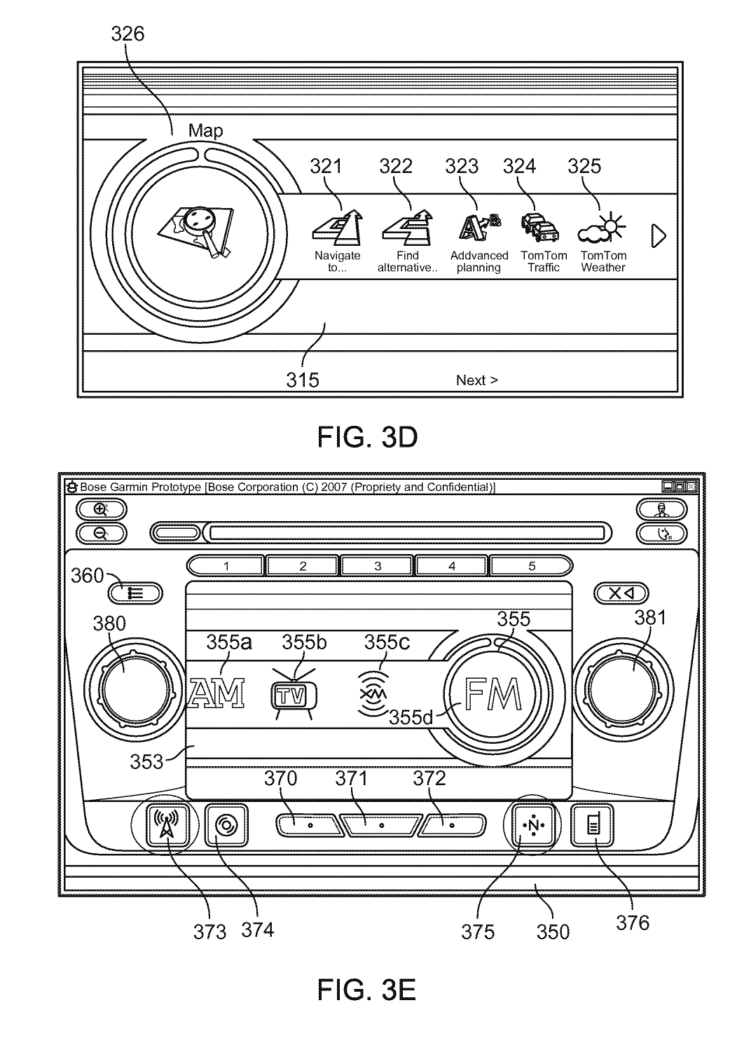

FIG. 3A is an example of a graphical user interface for a first type of navigation system, which contains elements that may be integrated into a native user interface of the entertainment system. This user interface includes a main navigation menu 301. The main navigation menu 301 contains three main navigation menu items, “Where to?” 302, “View Map” 303, and “Travel Kit” 304. These menu items can be used to invoke various functions available from the navigation system, such as mapping out a route to a destination. In this example, each menu item is associated with an icon. As stated above, an icon is a graphic symbol associated with a menu item or a functionality. For example, menu item 302—the “Where to” function—is associated with a magnifying glass icon, 307. Menu item 303—the “View Map” function—is associated with a map icon, 308. Menu item 304—the “Travel Kit” function—is associated with a suitcase icon, 309.

The main navigation menu 301 also contains a side menu 306, which includes various menu items, in this case: settings, quick settings, phone, and traffic. The functions associated with these menu items, which relate, e.g., to initiating a phone call or retrieving setting information, are also associated with corresponding icons, as shown in FIG. 3A. For example, the function of retrieving traffic information is associated with an icon 305, which is a shaded diamond with an exclamation mark inside.

Navigation system icons 307, 308, and 309 are menu items that are at a same hierarchical level. More specifically, the menu items are part of a hierarchical menu, which may be traversed by selecting a menu item at the top of the hierarchy, and drilling-down to menu items that reside below.

FIG. 3B shows an integrated main menu 315, which may be generated by software in entertainment system 102 and displayed on display screen 114. This main navigation menu may be accessed by pressing the navigation source button 375 shown in FIG. 3E. The main navigation menu is generated by integrating icons 311, 312, 313, and 314 associated with the navigation system into an underlying native user interface associated with the entertainment system. The “native” user interface may include, e.g., display features, such as frames, bars, or the like having a particular color, such as orange. The same bitmap data or scaled bitmap data of the icons may be used because the images defined by such data represent icons that are familiar to a user of the navigation system, even though these icons are displayed on the entertainment system and in a format that is consistent with the entertainment system. As a result, the user need not learn a new set of icons, but rather can use the navigation system through the entertainment system using familiar icons. When an icon is active (ready for selection by the user), it may be enlarged to differentiate it from other selections, as shown by the enlarged icon 311 as compared to the size of 312, 313, and 314. In addition, the icon may be highlighted by a circle to further differentiate it from other selections as shown in FIG. 3B.

In FIG. 3B, icon 312, which is the same as icon 307 in FIG. 3A, is associated with “Where to” functionality. Icon 313, which is the same as icon 305 in FIG. 3A, is associated with “Traffic” control functionality of the navigation system. Icon 314, which does not have a corresponding icon in FIG. 3A, is associated with “Trip Info” functionality. Icon 311, which is the same as icon 308, is associated with “View Map”. These icons, along with their associated character strings, may be retrieved by the entertainment system from the navigation system after the navigation system is connected to the entertainment system, and then stored as bitmap data in a storage device of the entertainment system or in other memory that is accessible thereto. Alternatively the icons and other data (e.g., character strings) may be transmitted to the entertainment system when the navigation system is connected to the entertainment system. In another alternative, the icons may be pre-stored in the entertainment system and retrieved for display when the type of the navigation system is identified. For example, upon connecting to the vehicle's entertainment system, the navigation system may transmit its identity to the entertainment system as part of the handshake protocol between the entertainment system and the navigation system. Upon receiving the identity of the navigation system, software in the entertainment system may access a storage device and retrieve the pre-stored icon data associated with the identified navigation system. The software incorporates these icons and associated functionalities into the entertainment system's native user interface, thereby generating a combined interface that includes icons that are familiar to the navigation system user.

In the combined interface of FIG. 3B, the icons from the navigation system may be rearranged and populated into a different hierarchical structure on the entertainment system, as shown. For example, side menu bar 306 in FIG. 3A is not present in FIG. 3B. But, icon 305 on the side menu bar 306 is presented in FIG. 3B, along with icons 307 and 308. Icon 309 is not mapped into FIG. 3B. In FIG. 3B, icon 312 (icon 307 in FIG. 3A) is at the same hierarchical level as icon 313 (icon 305 in FIG. 3A). A user may scroll through these icons to select an icon by either consecutively pressing the navigation source button 375 shown in FIG. 3E or by rotating the inner knob of a physical dual concentric knob 381 shown in FIG. 3E, and thus invoke a function associated with that icon, e.g., for display of a map on the entertainment system's display device by pressing the dual concentric knob 381 shown in FIG. 3E or by expiration of a time-out associated with that main navigation menu 315.

FIG. 3C shows screens of graphical user interfaces for a second type of navigation system, which is different from the navigation system shown in FIGS. 3A and 3B. User interface screens 331, 332, and 333 are components of a single main menu, and may be viewed by scrolling from screen-to-screen via arrow 335 The main menu includes menu items such as, “Navigate to” 341, “Find Alternative” 342, “TomTom Traffic” 343, “Advanced planning” 351, “Browse map” 352, “TomTom Weather” 361, and “TomTom Plus services” 362. Each menu item corresponds to a functionality that is available from the navigation system. For example, “Navigate to” provides directions to a particular location, “TomTom Traffic” provides traffic information, and “TomTom Weather” provides weather information for a particular location. As was the case above, each menu item from user interface screens 331, 332, and 333 is represented by a corresponding icon that is unique to that menu item. The menu items also may be hierarchical in that a user may drill down to reach other menu items represented by other icons (not shown).

The menu items of FIG. 3C may be integrated into the native user interface of the entertainment system, as was described above with respect to the entertainment system of FIG. 3B. FIG. 3D shows another version of an integrated main navigation menu 315, which may be generated by software in entertainment system 102 and displayed on display screen 114. The main menu is generated by integrating icons associated with the navigation system of FIG. 3C (e.g., 341, 342, 343, etc.), and their corresponding functionality, into the underlying native user interface associated with the entertainment system. As was the case above, the “native” user interface may include display features associated with the native user interface of the entertainment system. The icons from the navigation system of FIG. 3C may be mapped to the graphical user interface of FIG. 3D in the manner described above.

When mapping icons from the navigation system user interface screen shown in FIG. 3C to the entertainment (integrated) user interface screen shown in FIG. 3D, some icons may be removed. For example, icon “TomTom Plus services” 362, is absent from FIG. 3D. The sequence of the icons may also be altered. For example, icon “Advanced planning” 323 is adjacent to icon “Find alternative” 322 in FIG. 3D, while in FIG. 3C icon “Advanced planning” 351 is not adjacent to icon “Find alternative” 342. As described prior, icons are mapped from the navigation system to the entertainment system. For example, the “Map” icon 326 is the same icon as icon 352 in FIG. 3C which associated with “Browse Map” functionality. Icon 321, which is the same as icon 341 in FIG. 3C, is associated with the “Navigate to” control functionality of the navigation system. Icon 322, which is the same as icon 342 in FIG. 3C, is associated with the “Find Alternative” control functionality of the navigation system. Icon 323, which is the same as icon 351 in FIG. 3C, is associated with the “Advanced Planning” control functionality of the navigation system. Icon 324, which is the same as icon 343 in FIG. 3C, is associated with the “TomTom Traffic” functionality of the navigation system. Icon 325, which is the same as icon 361 in FIG. 3C, is associated with the “TomTom Weather” functionality of the navigation system. As described prior, when an icon is active (ready for selection by the user), it may be enlarged to differentiate it from other selections, as shown by the enlarged icon 326 as compared to the size of 321, 322, 323, 324 and 325. In addition, the icon may be highlighted by a circle to further differentiate it from other selections as shown in FIG. 3D.

FIG. 3E shows an exemplary human-machine user interface screen 350 for the entertainment system. In this example, the human-machine user interface screen includes, among other things, two physical dual concentric knobs 380 and 381. FIG. 3E, also shows a graphical user interface screen 353 that contains menu bar 355. Menu bar 355 contains icons associated with audio sources AM 355a, TV 355b, XM 355c and FM 355d. In FIG. 3E, the graphical user interface screen 353 is displaying the main broadcasted media menu as opposed to the integrated main navigation menu 315. As described prior, the main navigation menu may be accessed by pressing the navigation source button 375. Similarly, the main broadcasted media menu may be accessed by pressing the broadcasted media source button 373. Similarly, the main stored media menu (not shown) may be accessed by pressing the stored media source button 374. Similarly, the main phone menu (not shown) may be accessed by pressing the phone source button 376.

As explained above, the human-machine interface refers to the physical interface between the human operating a system and the device functionality. In this context, the navigation system human-machine interface has one set of controls. Most navigation system human-machine interface's are touch screens, although they may also have buttons, microphone (for voice input), or other controls. The vehicle entertainment system also has a human-machine interface with a second set of controls. The controls of the vehicle system may be the same, similar, or different than those of the navigation system.

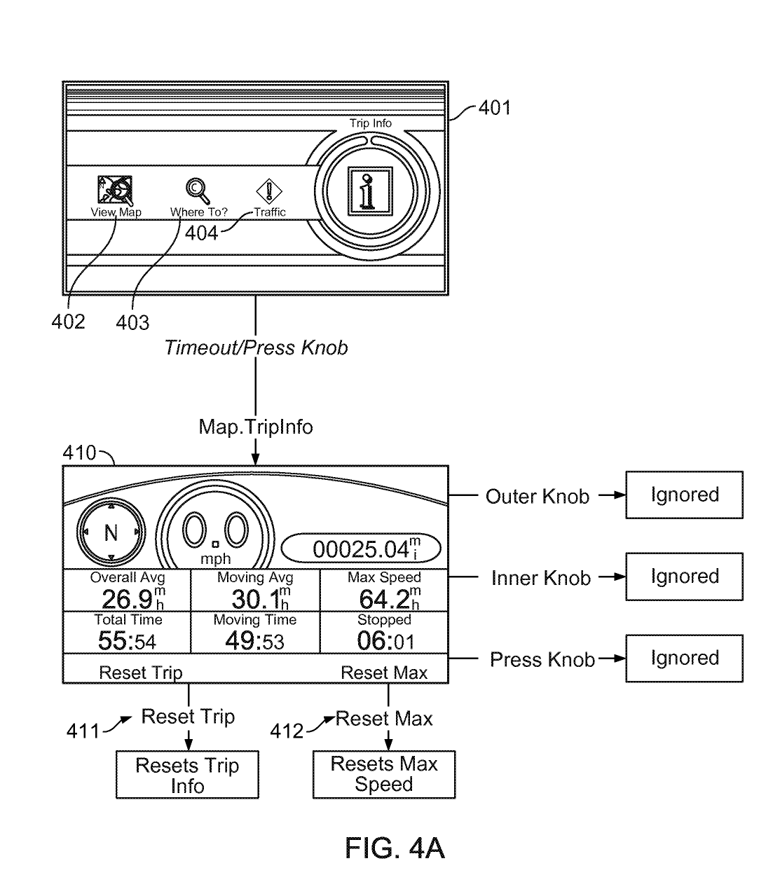

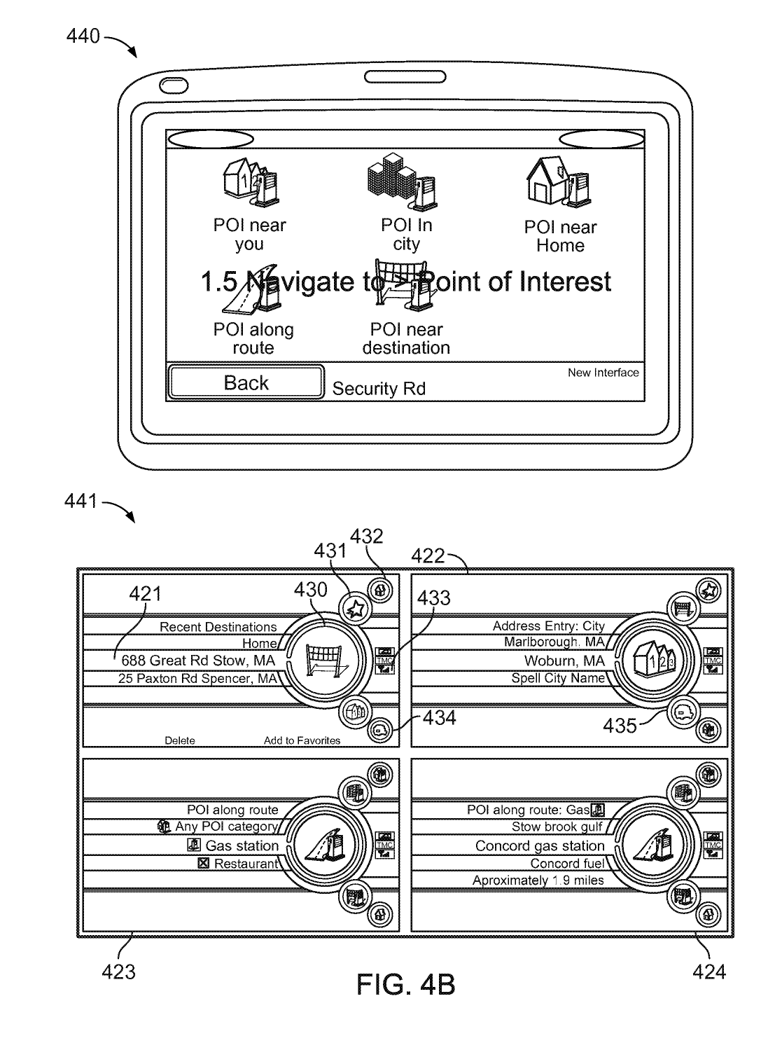

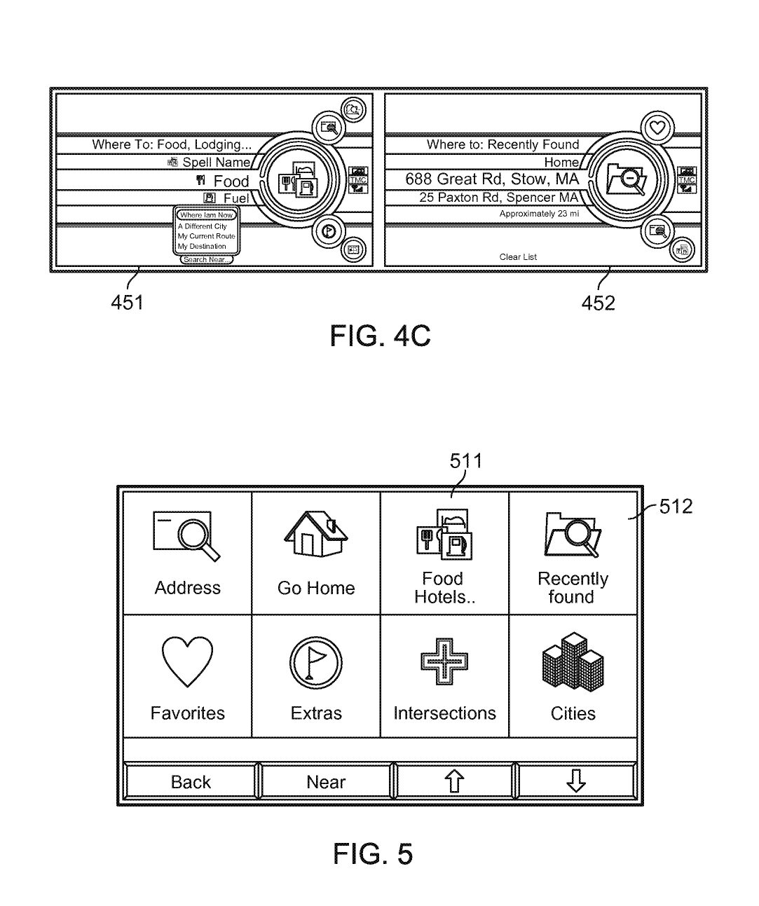

Mapping the human-machine interfaces may be conceptualized using a Venn diagram with two circles. One circle represents the set of human-machine interface controls for the navigation system, and one circle represents the set of controls for the vehicle system. The circles can either be completely separated, have a region of intersection, or be completely overlapping. The sizes of the circles can differ depending on the number of controls of each system. Within the circles, there are a number of discrete points representing each control that is available. What is done here is to map one set of controls to another on a context-sensitive basis. For example, in certain system states, a series of icons on a touch screen may be mapped to a series of circles with associated icons that can be scrolled through by rotating one of the concentric knobs. For example, in block 421 in FIG. 4B, a user can rotate a concentric knob to scroll through icons 430, 431, 432, 433, and 434. In other system states, icons on a touch screen may be mapped to a different control, such as a programmable button (the function of the button can change with system state). In another example, settings icon 306 on the touch screen of the navigation device shown in FIG. 3A may be mapped to programmable physical button 360 on FIG. 3E. When the entertainment system is configured to control the navigation system, pressing button 360 will bring up a settings menu associated with the navigation system. When the entertainment system is configured to control some other system, such as the music library, pressing button 360 will bring up an options menu associated with the music library function.

The fact that there are different controls can be beneficial. For example, referring to a user interface screen 331 of FIG. 3C, there are five icons shown, plus an arrow. Touching the arrow causes additional icons to show. All of these icons are at the same hierarchal level, but the size of the screen limits the number that is visible at any one time. The navigation system human-machine interface requires a user to touch the screen on the arrow to show different screens with different sets of icons showing. In many states, this navigation function is mapped to a rotary knob associated with the entertainment system. Rotating the knob causes a set of circles arranged in a semi circle (e.g., FIG. 4B) to rotate clockwise or counter clockwise as the rotary control is rotated. Each circle corresponds to one of the icons on the touch screen. In this case, an icon is selected by rotating the control until the desired icon is centered on the display (sometimes the rotary knob needs to be pushed to select the function associated with the icon, sometimes not, depending on the system state). However, the rotating circle can have an arbitrary number of icons that that can be scrolled. Only five circles at a time are shown in the example of FIG. 4B, but rotation of the knob allows one to scroll through all of the icon choices at this hierarchy level, without having to go to a new screen. The rotary knob enables the user to easily scroll through a larger number of icons (that represent functions the navigation system can perform) that one can interact with on a small touch screen.

In some cases, it has been determined that certain functions should be associated with a button (a soft button or a programmable function button), rather than one of the circle elements that scrolls with a rotary control. For example, the “settings” function represented by the wrench icon of FIG. 3A may be mapped to button 360 shown on FIG. 3E. Button 360 is the “options” button. It brings up settings in various system states (e.g., settings for the CD player, FM, phone, etc. depending on which state the system is in).

Some aspects of the organizational structure of the human-machine user interface elements may be altered so as to provide a better overall experience for the user. In some examples, the menu structure of a navigation system may be logically inconsistent with the corresponding menu structure of the entertainment system. The hierarchical structure of the navigation system may be re-organized. The relative level associated with a menu item may be changed. A lower level menu item may be moved to a higher level, or vice versa.

FIG. 4A is a user interface flow chart, which depicts an operation of the integrated user interface containing elements of both the navigation system and the entertainment system. In FIG. 4A, screen shot 401 shows a different icon selection highlighted 405 within the main navigation menu 315. The icons 402, 403, 404, and 405 are the same icons 311, 312, 313, and 314 of FIG. 3B. However, in FIG. 4A, trip info icon 405 is highlighted and is enlarged indicating that the icon is active for selection as previously described. When a user selects icon 402, 403, 404, or 405, software in the entertainment system takes the user to the next level under the navigation main menu. In FIG. 4A, when a user presses the concentric knob to select trip info soft functionality or when a user scrolls through the main menu and highlights the trip info soft functionality without pressing the concentric knob, the system times out and selects the trip info soft functionality, and the software provides a next level of navigation functionality, namely “trip info” display view 410. In “trip info” display view 410, two navigational features of the navigation system—reset trip 411 and reset max 412—are mapped to two programmable buttons of an array of three programmable buttons 370, 371, and 372 that are lined along the bottom (or top) of the entertainment system display.

In some examples, menu items associated with navigational features may be mapped onto a concentric knob provided on the entertainment system. Generally, the outer knob and the inner knob of a concentric knob are associated with different levels of a hierarchy. For example, a concentric knob may be configured to move to a previous/next item when the outer knob is turned, to display a scroll list when the inner knob is turned, and to actuate a control functionality when the knob is pressed. When the system is at the navigation level of the “trip info” display view, shown as 410 in FIG. 4A, the physical concentric knobs, 380 and 381, have no functions mapped to them.

FIG. 4B shows a pre-integration user interface and integrated user interfaces associated with a navigation system. Screen shot 440 shows the user interface of the navigation system before it has been mapped into the entertainment system user interface 441. In user interface screen 441, four example screens 421, 422, 423, and 424 are presented. User interface screen 421 shows recent destinations. These menu items can be scrolled though using the inner rotary knob of knob 381 and can be selected when knob 381 is pressed or a time-out is exceeded. When the user selects menu item 433 by rotating the outer rotary knob of knob 381, the user is brought to user interface screen 422. User interface screen 422 allows a user to find a place of interest via an address entry. User interface screen 422 also allows a user to spell out the name of the city if the city name is not contained in the list. When a user rotates the outer rotary knob of knob 381 to select menu item 435, the user is taken to user interface screen 423. User interface screen 423 allows a user to search through categories of point of interest (POI) along route. The categories of POI along a route may include gas stations, restaurants, and the like. If a user selects the gas station category by pressing the dual concentric knob 381, the user is taken to user interface screen 424. User interface screen 424 allows a user to scroll to a specific gas station by rotating the inner rotary knob of knob 381 and to enter a selection by pressing the dual concentric knob 381. These user interface screens retain the same graphical characteristics of the entertainment system, but they contain icons used in the navigation system.

FIG. 5 shows a screen shot of a graphic user interface for a Garmin 660 navigation system, that is different from the TomTom 910 navigation system depicted in FIG. 4B. The user interface screen shown in FIG. 5 allows a user to select destination categories, such as “Food, Lodging” as represented by menu item 511, or “Recently Found” as represented by menu item 512. This user interface screen is shown after the “Where to” icon 302 is selected by pressing the touch screen when in the top level menu 301 as shown in FIG. 3A.

FIG. 4C shows integrated user interfaces for the entertainment system that are presented when the “Where to” icon 312 in FIG. 3B has been selected. In this instance, the “Where to” functionality of the navigation system as shown in FIG. 5 is mapped to the integrated user interface of FIG. 4C. The icon associated with menu item 511 is remapped into user interface screen 451. The icon associated with menu item 512 is remapped into user interface screen 452. Because the entertainment system is connected to a different navigation system in this example, the icons, navigational functions, and the character strings differ from those shown in FIG. 4B. As was the case above, the icons and the character strings retain their characteristics from the navigation system, but are incorporated into the entertainment system's interface to produce a combined user interface.

In some examples, the entertainment system 102 can support more than one portable navigation system. For example, a user may disconnect the first navigation system connected to the entertainment system 102 and connect a different portable navigation system. The entertainment system may be able to generate a second integrated user interface using the elements of the user interface of the second portable navigation system and control the second portable navigation system through the second integrated user interface.

In some examples, the entertainment system 102 can support more than one portable system at the same time (e.g., two portable navigation systems, a portable navigation system and an MP3 player, a portable navigation system and a mobile telephone, a portable navigation system and a personal digital assistant (PDA), an MP3 player and a PDA, or any combination of these or other devices). In this case, the entertainment system 102 may be able to integrate elements of (e.g., all or part of) the user interfaces of two (or more) such devices into its own user interface in the manner described herein. The entertainment system 102 may generate a combined user interface to control the portable navigation system and the other device(s) at the same time in the manner described herein.

Audio from the navigation system 104 and entertainment system 102 may also be integrated into the entertainment system. The navigation system may generate audio signals, such as a voice prompt telling the driver about an upcoming turn, which are communicated to the entertainment system 102 through audio signals 222 as described above. At the same time, the entertainment system 102 may generate continuous audio signals, such as music from the radio or a CD. In some examples, a mixer in the head unit 106 determines which audio source takes priority, and directs the prioritized audio signals to speakers 226, e.g., to a particular speaker. A mixer may be a combiner that sums audio signals to form a combined signal. The mixer may also control the level of each signal that is summed. When a navigation voice prompt comes in, the audio signals can be routed in different ways with their levels adjusted so that the navigation voice prompt will be more audible to vehicle occupants.

As indicated above, a mixer has the capability of directing a signal to a specific speaker. For example, when a turn is coming up, and the navigation system 104 sends an announcement via audio signals 222 (see FIG. 2), the mixer may reduce the volume of music and play the turn instructions at a relatively loud volume. If the entertainment system is receiving vehicle information 203, it may also base the volume of the entertainment system on factors that may affect ambient noise, e.g., increasing the volume to overcome road noise based on the vehicle speed 208, or ambient noise directly sensed within the vehicle. In some examples, the entertainment system may include a microphone to directly discover noise levels and to compensate for those noise levels by raising the volume, adjusting the frequency response of the system, or both. The audio from the lower-priority source may be silenced completely or may only be reduced in volume and mixed with the louder high-priority audio. The mixer may be an actual hardware component or may be a function carried out by the processor 120. The entertainment system may have the capability of determining the ambient noise present in the vehicle, and adjusting its operation to compensate for the noise. It can also apply this compensation to the audio signal received from the navigation system to ensure that the audio from the navigation system is always audible, regardless of the noise levels present in the vehicle.

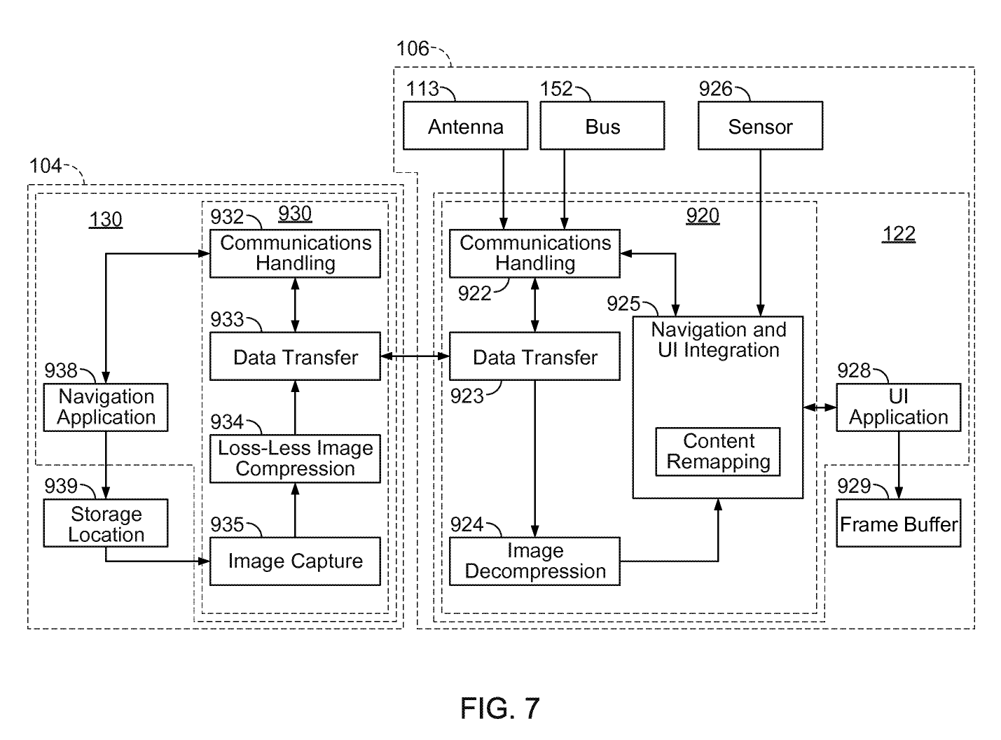

FIG. 7 depicts one possible implementation of software-based interaction between the navigation system 104 and the head unit 106 that allows images made up of visual elements provided by the navigation system 104 to be displayed on the screen 114, and that allows a user of the head unit 106 to interact with the navigation function of the navigation system 104. The display of images and the interactions that may be supported by this possible implementation may include those discussed with regard to any of FIGS. 3B and 3D, FIGS. 4B-4C.

As earlier discussed, the head unit 106 incorporates software 122. A portion of the software 122 of the head unit 106 is a user interface application 928 that causes the processor 120 to provide the user interface 112 through which the user interacts with the head unit 106. Another portion of the software 122 is software 920 that causes the processor 120 to interact with the navigation system 104 to provide the navigation system 104 with vehicle data such as speed data, and to receive visual and other data pertaining to navigation for display on the screen 114 to the user. Software 920 includes a communications handling portion 922, a data transfer portion 923, an image decompression portion 924, and a navigation and user interface (UI) integration portion 925.

As also earlier discussed, the navigation system 104 incorporates software 130. A portion of the software 130 is software 930 that causes the processor 128 to interact with the head unit 106 to receive the navigation input data and to provide visual elements and other data pertaining to navigation to the head unit 106 for display on the screen 114. Another portion of the software 130 of the navigation system 104 is a navigation application 938 that causes the processor 128 to generate those visual elements and other data pertaining to navigation from the navigation input data received from the head unit 106 and data it receives from its own inputs, such as GPS signals. Software 930 includes a communications handling portion 932, a data transfer portion 933, a loss-less image compression portion 934, and an image capture portion 935.

As previously discussed, each of the navigation system 104 and the head unit 106 are able to be operated entirely separately of each other. In some embodiments, the navigation system 104 may not have the software 930 installed and/or the head unit 106 may not have the software 920 installed. In such cases, it would be necessary to install one or both of software 920 and the software 930 to enable the navigation system 104 and the head unit 106 to interact.

In the interactions between the head unit 106 and the navigation system 104 to provide a combined display of imagery for both navigation and entertainment, the processor 120 is caused by the communications handling portion 922 to assemble GPS data received from satellites (perhaps, via the antenna 113 in some embodiments) and/or other location data from vehicle sensors (perhaps, via the bus 152 in some embodiments) to assemble navigation input data for transmission to the navigation system 104. As has been explained earlier, the head unit 106 may transmit what is received from satellites to the navigation system 104 with little or no processing, thereby allowing the navigation system 104 to perform most or all of this processing as part of determining a current location. However, as was also explained earlier, the head unit 106 may perform at least some level of processing on what is received from satellites, and perhaps provide the portable navigation unit 104 with coordinates derived from that processing denoting a current location, thereby freeing the portable navigation unit 104 to perform other navigation-related functions. Therefore, the GPS data assembled by the communications handling portion 922 into navigation input data may have already been processed to some degree by the processor 120, and may be GPS coordinates or may be even more thoroughly processed GPS data. The data transfer portion 923 then causes the processor 120 to transmit the results of this processing to the navigation system 104. Depending on the nature of the connection established between the navigation system and the head unit 106 (i.e., whether that connection is wireless (including the use of either infrared or radio frequencies) or wired, electrical or fiber optic, serial or parallel, a connection shared among still other devices or a point-to-point connection, etc.), the data transfer portion 923 may serialize and/or packetize data, may embed status and/or control protocols, and/or may perform various other functions required by the nature of the connection.

Also in the interactions between the head unit 106 and the navigation system 104, the processor 120 is caused by the navigation and user interface (U) integration portion 925 to relay control inputs received from the user interface (UI) application 928 as a result of a user actuating controls or taking other actions that necessitate the sending of commands to the navigation system 104. The navigation and UI integration portion relays those control inputs and commands to the communications handling portion 922 to be assembled for passing to the data transfer portion 923 for transmission to the navigation system 104.

The data transfer portion 933 causes the processor 128 to receive the navigation input data and the assembled commands and control inputs transferred to the navigation system 104. The processor 128 may further perform some degree of processing on the received navigation input data and the assembled commands and control inputs.

The processor 128 is then caused by the navigation application 938 to process the navigation input data and to act on the commands and control inputs. As part of this processing, the navigation application 938 causes the processor 128 to generate visual elements pertaining to navigation and to store those visual elements in a storage location 939 defined within storage 164 (as shown in FIG. 1C) and/or within another storage device of the navigation system 104. In some embodiments, the storage of the visual elements may entail the use of a frame buffer defined through the navigation application 938 in which at least a majority of the visual elements are assembled together in a substantially complete image to be transmitted to the head unit 106. It may be that the navigation application 938 routinely causes the processor 128 to define and use a frame buffer as part of enabling visual navigation elements pertaining to navigation to be combined in the frame buffer for display on the screen 174 of the navigation system 104 when the navigation system 104 is used separately from the head unit 106. It may be that the navigation application continues to cause the processor 128 to define and use a frame buffer when the image created in the frame buffer is to be transmitted to the head unit 106 for display on the screen 114.

Other implementations are within the scope of the following claims and other claims to which the applicant may be entitled. Elements of different implementations described herein may be combined to form different implementations not specifically described.

What is claimed is:

1. A method comprising:
integrating elements of a first graphical user interface into a second graphical user interface to produce a combined graphical user interface, wherein the first graphical user interface is for a portable navigation system and the second graphical user interface is for a vehicle media device; and
controlling the vehicle media device and the portable navigation system through the combined graphical user interface.

2. The method of claim 1, wherein the combined graphical user interface is displayed on the vehicle media device.

3. The method of claim 2, wherein the first graphical user interface comprises at least one icon; and
wherein the method comprises incorporating the at least one icon into the combined graphical user interface.

4. The method of claim 2, wherein the first graphical user interface comprises at least one function; and
wherein the method comprises incorporating the at least one function into the combined graphical user interface.

5. The method of claim 4, wherein the combined user interface provides access to both the vehicle media device and the portable navigation system.

6. The method of claim 4, wherein the combined graphical user interface incorporates navigation data and/or vehicle information that are transmitted from the portable navigation system; and
wherein the combined graphical user interface comprises display characteristics associated with the vehicle media device.

7. The method of claim 1, wherein the combined graphical user interface is displayed on the portable navigation system.

8. The method of claim 1, wherein the combined graphical user interface is displayed on the vehicle media device using pre-stored bitmap data residing on the vehicle media device.

9. The method of claim 1, wherein the combined graphical user interface is displayed on the vehicle media device using bitmap data transmitted from the portable navigation system.

10. A method comprising:
mapping first control features of a portable navigation system to second control features of a vehicle media device; and
using the second control features to control a graphical user interface that is displayed on the vehicle media device, the graphical user interface comprising first user interface elements of the portable navigation system and second user interface elements of the vehicle media device.

11. The method of claim 10, wherein the first control features comprise elements of a human-machine interface for the portable navigation system; and
wherein the second control features comprise elements of a human-machine interface for the vehicle media device.

12. The method of claim 10, wherein at least one of the second control features comprises a soft button on the graphical user interface.

13. The method of claim 10, wherein at least one of the second control features comprises a concentric knob, the concentric knob including an outer knob and an inner knob, the outer knob and the inner knob for controlling different functions via the graphical user interface.

14. The method of claim 10, wherein the second control feature comprises displaying a route view, a map view, or a driving view, wherein data for those views are received at the vehicle media device from the portable navigation system.

15. A vehicle media device comprising:
a display device to display a graphical user interface;
a storage device to store instructions that are executable; and
a processor to execute the instructions to:
integrate elements of a first graphical user interface into a second graphical user interface to produce a first combined graphical user interface, wherein the first graphical user interface is for a first portable navigation system and the second graphical user interface is for the vehicle media device; and
control the first portable navigation system and the vehicle media device through the first combined graphical user interface.

16. The method of claim 15, wherein the first combined graphical user interface is displayed on the vehicle media device.

17. The vehicle media device of claim 16, wherein the first graphical user interface comprises at least one icon; and
wherein the processor executes instructions to incorporate the at least one icon into the first combined graphical user interface.

18. The vehicle media device of claim 15, wherein the processor executes instructions to map first control features of the first portable navigation system into second control features of the vehicle media device.

19. The vehicle media device of claim 15, wherein the vehicle media device is configured to integrate elements of a third graphical user interface into the second graphical user interface to form a second combined graphical user interface;
wherein the third graphical user interface is for a portable device; and
wherein the vehicle media device is configured to control the second portable navigation system and the vehicle media device via the second combined graphical user interface.

20. One or more machine-readable media for storing instructions to cause a processing device of a vehicle media device to:
integrate elements of a first user interface with a second user interface to produce a combined graphical user interface, wherein the first user interface is for a portable navigation system and the second user interface is for a vehicle media device; and
control the portable navigation system and the vehicle media device through the combined graphical user interface.

21. The one or more machine-readable media of claim 20, wherein the instructions are for causing the combined graphical user interface to be displayed on the vehicle media device.

22. The one or more machine-readable media of claim 21, wherein the first graphical user interface comprises at least one icon; and
wherein the one or more machine-readable media comprise instructions to incorporate the at least one icon into the combined graphical user interface.

23. The one or more machine-readable media of claim 20, wherein the first graphical user interface comprises at least one function; and
wherein the one or more machine-readable media comprise instructions to incorporate the at least one function into the combined graphical user interface.

24. The one or more machine-readable media of claim 23, wherein the one or more machine-readable media comprise instructions to provide access to both the vehicle media device and the portable navigation system.

25. The one or more machine-readable media of claim 23, wherein the combined graphical user interface incorporates navigation data and/or vehicle information that are transmitted from the portable navigation system; and
wherein the combined graphical user interface comprises display characteristics associated with the vehicle media device.

26. One or more machine-readable media for storing instructions to cause a vehicle media device to:
map first control features of a portable navigation system to second control features of the vehicle media device; and
use the second control features to control a graphical user interface that is displayed on the vehicle media device, the graphical user interface comprising first user interface elements of the portable navigation system and second user interface elements of the vehicle media device.

27. An integrated system comprising a portable navigation system and a vehicle media device, wherein:
the integrated system comprises an integrated user interface that controls both the portable navigation system and the vehicle media device.

28. The integrated system of claim 27, wherein:
the vehicle media device comprises a microphone;
the portable navigation system comprises voice recognition software; and
the integrated system is configured to transmit voice data from the microphone to the voice recognition software.

29. The integrated system of claim 28, wherein:
the portable navigation system is configured to interpret the voice data as commands and to send the commands to the vehicle media device.

30. The integrated system of claim 28, wherein:
the portable navigation system is configured to interpret the voice data as commands and to process the commands on the navigation device.

31. The integrated system of claim 27, wherein:
the portable navigation system comprises a microphone;
the vehicle media device comprises voice recognition software; and
the integrated system is configured to transmit voice data from the microphone to the voice recognition software.

32. The integrated system of claim 31, wherein:
the vehicle media device is configured to interpret the voice data as commands and to send the commands to the portable navigation system.

33. The integrated system of claim 31, wherein:
the vehicle media device is configured to interpret the voice data as commands and to process the commands on the navigation device.

34. The integrated system of claim 27, wherein:
the vehicle media device is configured to receive traffic data from a broadcasted signal; and
the integrated system is configured to transmit the traffic data to the portable navigation system for use in route calculation.

35. The integrated system of claim 27, wherein:
the vehicle media device is configured to notify the navigation system that a collision has occurred; and
the portable navigation system is configured to send an emergency number and a verbal notification to the vehicle media device following the collision.

36. The integrated system of claim 27, wherein:
the vehicle media device is configured with a backup camera; and
the integrated system is configured to transmit a signal from the backup camera to the portable navigation system for display.

37. The integrated system of claim 27, wherein:
the vehicle media device is configured to receive global positioning system (GPS) signals;
the vehicle media device is configured to interpret the GPS signals and to calculate latitude data or longitude data therefrom; and
the integrated system is configured to pass the latitude data or longitude data to the portable navigation system.

38. The integrated system of claim 27, wherein:
the vehicle media device comprises a proximity sensor, the proximity sensor being configured to detect proximity of a user's hand to a predetermined location, and to generate an input to the vehicle media device; and
the integrated system is configured to cause the portable navigation system to generate a response based on the input from the proximity sensor.

39. The integrated system of claim 38, wherein the response generated by the portable navigation system is presented on the integrated user interface.

40. The vehicle media device of claim 27, wherein the integrated system is configured to identify a type of the portable navigation system when the portable navigation system is connected to the vehicle media device and to use stored icons associated with the type of the portable navigation system.

41. The vehicle media device of claim 15, wherein, when the first portable navigation system is disconnected, and a second portable navigation system is connected to the vehicle media device, the processor executes instructions to:
integrate elements of a third graphical user interface into a second graphical user interface to produce a second combined graphical user interface, wherein the third graphical user interface is for the second portable navigation system; and
control the second portable navigation system and the vehicle media device through the second combined graphical user interface.
